(19) United States
(12) Patent Application Publication
(10) Pub. No.: US 2015/0316698 A1
(43) Pub. Date: Nov. 5, 2015

(54) Illuminated Accessory Device

(71) Applicants: David Resnick, Ambler, PA (US); Tricia Resnick, Ambler, PA (US)

(72) Inventors: David Resnick, Ambler, PA (US); Tricia Resnick, Ambler, PA (US)

(21) Appl. No.: 14/694,137

(22) Filed: Apr. 23, 2015

Related U.S. Application Data
(60) Provisional application No. 61/986,239, filed on Apr. 30, 2014.

(51) Int. Cl. F21V 8/00; F21V 21/18; F21L 4/00; F21V 33/00; F21V 21/096; F21V 21/088

(52) U.S. Cl. CPC G02B 6/001; F21V 21/0965; F21V 21/0885; F21L 4/00; F21V 33/0008; F21V 21/18; F21W 2111/10

(57) ABSTRACT

An adjustable accessory device that illuminates when powered. The device comprises a fiber optic cable having a first end opposite a second end and a housing unit, wherein the housing unit includes one or more light sources and a power source. The first end of the cable is removably connected to the housing unit and the second end is adjustably secured thereto. The housing unit further includes a retracting mechanism that can allow the fiber optic cable to retract therein. The device functions as an illuminating necklace or similar accessory article that can adjust in length, wherein the light source projects light through the fiber optic cable. The device permits individuals who are exercising outdoors or performing other outside activities to be more visible to passing motorists so to avoid injuries.

### CROSS REFERENCE TO RELATED APPLICATION

This application claims the benefit of U.S. Provisional Application No. 61/986,239 filed on Apr. 30, 2014. The above identified patent application is herein incorporated by reference in its entirety to provide continuity of disclosure.

### BACKGROUND OF THE INVENTION

### Field of the Invention

The present invention relates to an illuminated accessory device. More specifically, the present invention provides a fiber optic cable having a first end opposite a second end and a housing unit, wherein the housing unit includes one or more light sources and a power source therein. The first end of the cable is removably connected to the housing unit and the second end is adjustably secured thereto. The housing unit further includes a retracting mechanism adapted to allow the fiber optic cable to retract therein. The power source powers the light source, wherein the light source illuminates the fiber optic cable.

Individuals who like to run, walk, or exercise near roadways at night are at risk of being injured because passing motorists may find these individuals difficult to see. Some people choose to wear reflective garments, but a motorist may not observe the reflection of the individual's garment until the motorist is too close to the individual, which mitigates the usefulness of the reflective garment. Some individuals choose to run with glow sticks, but they are bothersome to carry, can only be used for short durations, and cannot be turned off when the individual is finished with them. Therefore, there is a need in the prior art for an illuminated device that can be worn by a user to alert motorists to his or her presence, can last for an extended period of time, and can be turned off when not in use.

Devices have been disclosed in the prior art that relate to illuminated accessory devices. These include devices that have been patented and published in patent application publications. These devices generally relate to illuminated personal items, such as key chains, toys, and light-emitting systems for headgear. These devices include U.S. Pat. No. 8,529,082 to John Maxwell Baker et al. and U.S. Pat. No. 6,965,205 to Colin Piepgras et al. These devices, however, fail to provide a device comprising a fiber optic cable and a housing unit, wherein the housing unit includes one or more light sources and a power source therein. Furthermore, these devices fail to provide a mechanism adapted to allow the fiber optic cable to retract therein.

Other devices, such as U.S. Pat. No. 7,620,279 to Joseph and U.S. Pat. No. 5,727,577 to Post, generally relate to fiber optic illuminated items, such as shoe laces, a power cord safety indicator, a dental suction tube, and ornaments. These devices, however, fail to provide a device comprising a fiber optic cable and a housing unit, wherein the housing unit includes one or more light sources and one or more power sources therein. Furthermore, these devices fail to provide a mechanism adapted to allow the fiber optic cable to retract therein.

One other device, U.S. Pat. No. 7,255,468 to Capriola, relates to personal items that illuminate using fiber optic cable, wherein a power source and light source are included. This device, however, fails provide a device comprising a fiber optic cable and a housing unit, wherein the housing unit includes a mechanism adapted to allow the fiber optic cable to retract therein.

In light of the devices disclosed in the prior art, it is submitted that the present invention substantially diverges in design elements from the prior art and consequently it is clear that there is a need in the art for an improvement to existing illuminated accessory devices. In this regard the instant invention substantially fulfills these needs.

### SUMMARY OF THE INVENTION

In view of the foregoing disadvantages inherent in the known types of illuminated accessory devices now present in the prior art, the present invention provides a new illuminated accessory device wherein the same can be utilized for providing safety for the user when performing tasks outdoors at night and during periods of low light.

It is therefore an object of the present invention to provide a new and improved illuminated accessory device that has all of the advantages of the prior art and none of the disadvantages.

It is another object of the present invention to provide an illuminated accessory device comprising a fiber optic cable connected to a housing unit that contains a light source and a power source.

Another object of the present invention is to provide an illuminated accessory device comprising a retracting mechanism adapted to allow the fiber optic cable to retract therein.

Yet another object of the present invention is to provide an illuminated accessory device wherein the first end of the fiber optic cable is removably attached to the housing unit and the second end is adjustably secured to allow the device to fit around different parts of the body.

Another object of the present invention is to provide an illuminated accessory device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the illuminated accessory device.

FIG. 2 shows a perspective view of an embodiment of the light up accessory device being retracted into the housing unit.

FIG. 3 shows a diagram of the control circuit of the illuminated accessory device.

FIG. 4 shows a perspective view of an embodiment of the illuminated accessory device in use.

### DETAILED DESCRIPTION OF THE INVENTION

Reference is made herein to the attached drawings. Like reference numerals are used throughout the drawings to depict like or similar elements of the illuminated accessory device. For the purposes of presenting a brief and clear description of the present invention, the preferred embodiment will be discussed as used for maintaining visibility while performing tasks outdoors during darkness. The figures are intended for representative purposes only and should not be considered to be limiting in any respect.

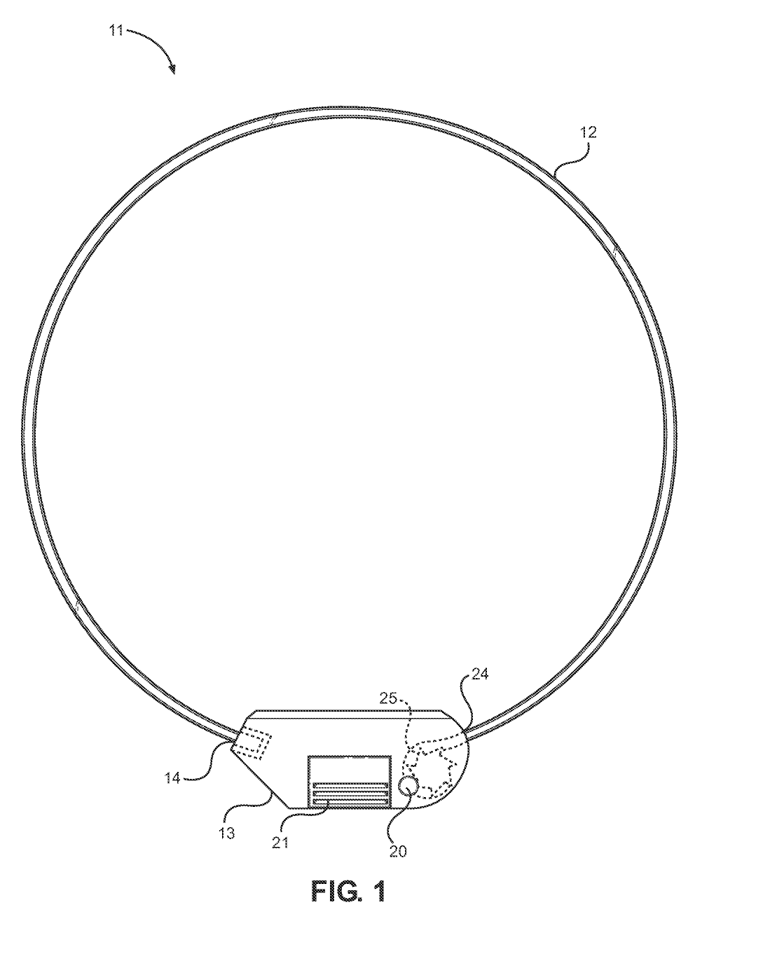

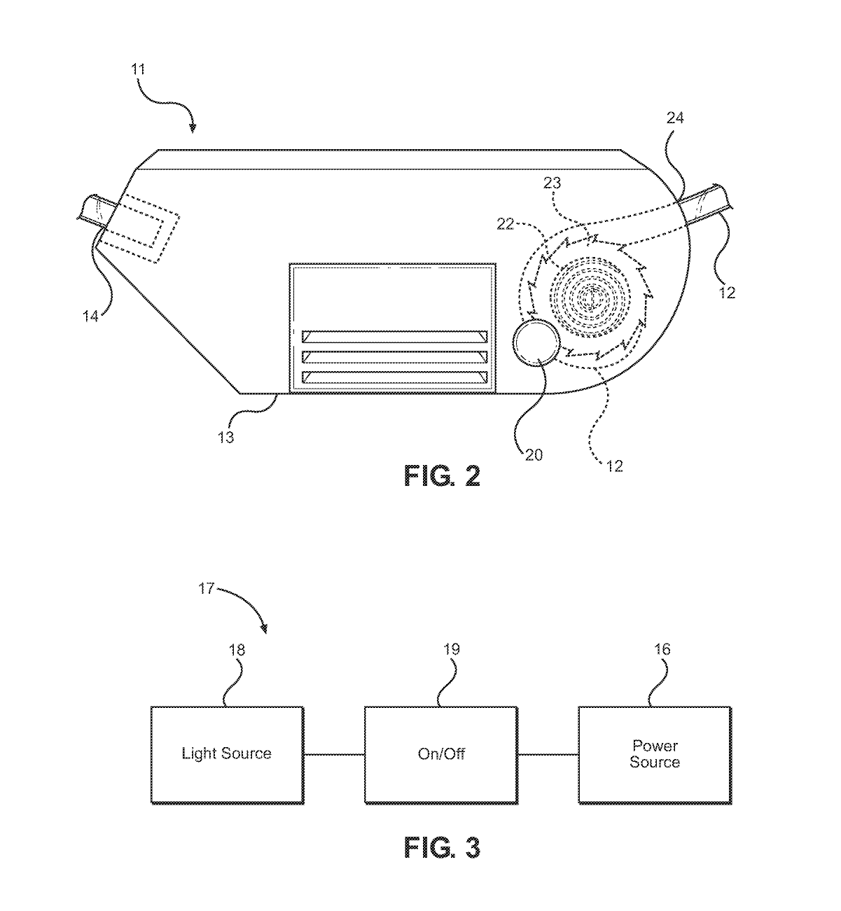

Referring now to FIGS. 1 and 2, there is shown a perspective view of an embodiment of the illuminated accessory device and a perspective view of an embodiment of the light up accessory device being retracted into the housing unit. The device 11 comprises a fiber optic cable 12 having a first end 14 opposite a second end 24 and a housing unit 13, wherein the housing unit 13 includes one or more light sources and one or more power sources therein. The first end 14 of the cable 12 is removably connected to the housing unit 13 and the second end 24 is adjustably secured thereto. The housing unit 13 further includes a retracting mechanism 25 adapted to allow the fiber optic cable 12 to retract therein and a cover 21 adapted to allow access to the light source and power source.

The housing unit 13 comprises a first end opposite a second end, wherein the first end of the housing unit 13 is removably connected to the first end 14 of the cable 12 and the second end of the housing unit 13 is adjustably secured to the second end 24 of the cable 12. Each end of the housing unit 13 comprises a channel preferably circular in configuration and substantially the same diameter as the diameter of the cable so the cable 12 can securely fit therein. The cable 12 can be removably secured to the first end of the housing unit 13 by any suitable fastener, such as a magnet or a clasp. The fiber optic cable 12 is preferably flexible with a clear jacket, such as side glow emitting fiber optic cable.

The second end 24 of the fiber optic cable 12 is permanently attached to the retracting mechanism 25 in the housing unit 13. The retracting mechanism 25 comprises several components adapted to allow the fiber optic cable 12 to partially retract into the housing unit 13 or retract to a specific position and lock in place. The mechanism 25 includes a recoil spring 22 adapted to provide force that can automatically rewind the cable within the housing unit 13 and a spool 23 on which a portion of the cable 12 can be wound. The interior end of the spring 22 is permanently connected to the housing unit 13 and the exterior end of the spring 22 is connected to the spool 23. The spool 23 includes a jagged circumference adapted to engage with a locking mechanism 20 so to allow the cable 12 to maintain a fixed position. The locking mechanism 20 includes an external piece and an internal piece, wherein the external piece 20 can be pressed down and then the internal piece is placed between the spool 23 teeth. The internal piece can include a spring adapted to release the internal piece from between the jagged teeth, thereby unlocking the mechanism 25.

Referring now to FIG. 3, there is shown a diagram of the control circuit of the illuminated accessory device. Both the light source 18 and power source 16 are contained within the housing unit. The illuminated accessory device includes a control circuit 17 in which the light source can be operated by an on and off switch 19. When in the on position, the light source 18 can illuminate the fiber optic tube. The light source is preferably a light emitting diode, but in alternate embodiments other types of light sources may be used. The light source 18 can be provided in a variety of colors. In some embodiments, the light source 18 can be removable so the colors can be interchanged. The power source 16 powers the light source 18 and is electrically connected to the on and off switch 19. The power source 16 may be one or more disposable or rechargeable batteries, wherein the batteries can be lithium ion, alkaline, or the like.

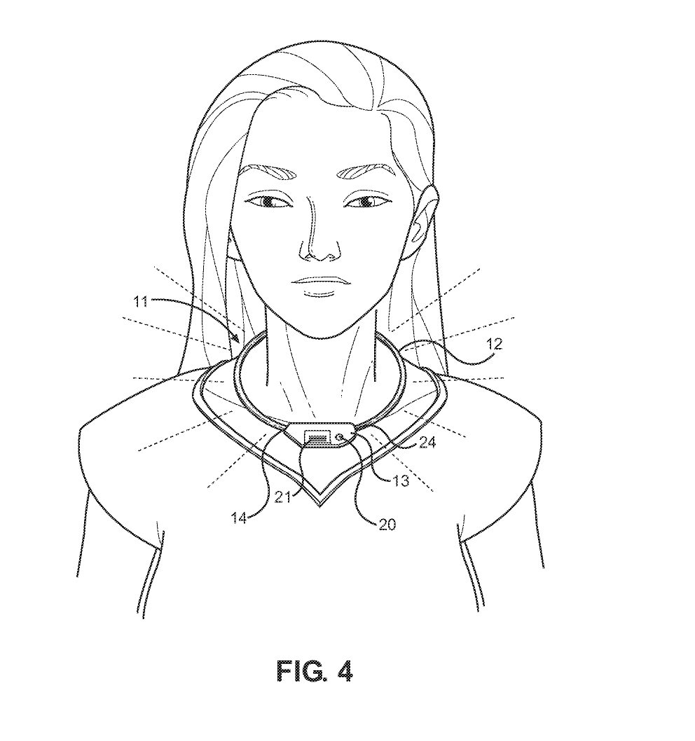

Referring now to FIG. 4, there is shown a perspective view of an embodiment of the illuminated accessory device in use. In operation, the user turns on the device by switching the control circuit to the on position. The second end 24 of the cable 12 is extended to the desired length. The cable 12 can be placed around a section of the body or an article of clothing that the user wishes to illuminate. Next, the user can fasten the first end 14 of the cable 12 into the housing unit 13. The locking mechanism 20 can be operated so to allow the cable 12 to be maintained in the desired position. The user can access the power source via the cover 21 if a new power source is needed.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. An illuminated accessory device, comprising:
a fiber optic cable having a first end and a second end;
a housing unit having a first end opposite a second end, wherein said first end is removably connected to said first end of said fiber optic cable and said second end is adjustably secured to said second end of said fiber optic cable;
one or more light sources included in said housing adapted to illuminate the fiber optic cable.

2. The illuminated accessory device of claim 1, wherein said one or more light sources is a light emitting diode.

3. The illuminated accessory device of claim 1, further comprising a power source adapted to illuminate said one or more light sources.

4. The illuminated accessory device of claim 1, further comprising a retracting mechanism adapted to retract said fiber optic cable into said housing unit, wherein said second end of said fiber optic cable is secured thereto.

5. The illuminated accessory device of claim 4, further comprising a locking mechanism adapted to secure said fiber optic cable at a fixed position.

6. The illuminated accessory device of claim 4, wherein said retracting mechanism comprises a recoil spring adapted to provide force that can automatically rewind said fiber optic cable and a spool on which a portion of said fiber optic cable can be wound.

7. The illuminated accessory device of claim 5, wherein said locking mechanism comprises an external piece and an internal piece, wherein said external piece is adapted to be pressed down, thereby said internal piece is placed within said retracting mechanism, thereby preventing said fiber optic cable from retracting into said housing unit.

8. The illuminated accessory device of claim 7, wherein said internal piece comprises a spring adapted to release said internal piece from within said retracting mechanism, thereby unlocking said retracting mechanism.

9. The illuminated accessory device of claim 3, further comprising a removable cover on said housing unit adapted to provide access to said one or more light sources and said power source.

10. The illuminated accessory device of claim 1, wherein said first end of said housing unit is removably connected to said first end of said fiber optic cable by a magnet or a clasp.
